(19) United States
(12) Patent Application Publication
(10) Pub. No.: US 2004/0078256 A1
(43) Pub. Date: Apr. 22, 2004

(54) Method, system, and mobile agent for event scheduling

(76) Inventors: Roch Glitho, Montreal (CA); Edgar Olougouna, Montreal (CA); Samuel Pierre, Montreal (CA)

Correspondence Address: ERICSSON RESEARCH CANADA, 8400 DECARIE BLVD., MONTREAL, QC, H4P 2N2, CA

(21) Appl. No.: 10/273,849

(22) Filed: Oct. 21, 2002

(51) Int. Cl. G06F 17/60

(52) U.S. Cl. 705/8

(57) ABSTRACT

A method, system, and scheduler mobile for scheduling events on behalf of participants, wherein the agent receives from the event organizer a list of participants along with an intended timeframe for the event. In a first embodiment, the agent is dispatched to at least one calendar server storing participants' calendar information, retrieves that information for the intended timeframe, and schedules the event. If no suitable timeframe exists for all participants, the agent invokes negotiating agents of the participants for rescheduling previously booked events conflicting with the multi-party event. According to a second embodiment, a plurality of scheduler mobile agents are dispatched on a plurality of calendar servers. Each scheduler mobile agent retrieves calendar information related to participants whose calendars are stored on the server, and creates a timeframe proposal for the event. The scheduler mobile agents further negotiate with each other based on the timeframe proposals for the final event.

### BACKGROUND OF THE INVENTION

1. Field of the Invention

The present invention relates to event scheduling, and in particular to the field of event scheduling using electronic calendars.

2. Description of the Related Art

Various events require the participation of several parties. In general, multiparty events such as activity days, meetings, teleconferences, and workshops, are an everyday reality, especially in an office environment. In such administrative environments, the scheduling of multiparty events is a recurrent office task. The key issue inerrant to multiparty scheduling is always the availability of the targeted participants during a given timeframe.

The scheduling process remains manual in most cases. The organizer usually exchanges a number of e-mails and phone calls with the targeted participants in order to gather information on participant's availability. Other current solutions mostly rely on electronic agenda applications that are shared on servers. These tools allow event organizers to download the participant's agendas and to visually detect the best day and time for convening. In intranet-based arrangements, the electronic agendas are shared through centralized calendar/mail management systems. The meeting organizer may consult the other participants' electronic calendars in order to detect their availability, using, software applications such as Microsoft Outlook (TM) or Lotus Notes (TM).

The current scheduling process remains however stiff, tedious and time-consuming. For example, the prior art client/server-oriented tools provide limited customization for rescheduling previous low priority arrangements based on the participant's preferences. Besides, there is an obvious issue of scalability when the number of participants is so large that the number of calendars that need to be consulted is so important that it gets unmanageable. As a consequence, visually detecting the suitable timeframe for all targeted participants can easily become a nightmare.

Although there is no prior art solution as the one proposed hereinafter for solving the above-mentioned deficiencies, the U.S. Pat. No. 5,850,517 bears some relation with the field of the present invention. In the U.S. Pat. No. 5,850,517 there is described client/server architecture for use in conjunction with mobile clients that communicate requests for wireless communications. The requests from the client and the subsequent responses by the server are transferred between the client/server connection to an intermediary agent, which operates asynchronously to the client and to the server. The U.S. Pat. No. 5,850,517 definitely fails to teach or suggest the use of mobile agents in the context of event scheduling.

The U.S. Pat. No. 6,272,528 teaches a computer system provided for delivery of financial services, the system comprising a number of user computers connected to a plurality of server computers by way of a network, like the Internet. The system creates a mobile agent which obtains details of the user's requirements, obtains financial information from the server computer on behalf of the user in the light of some user requirements, and then transports itself to the user's computer to deliver the financial information the user. The U.S. Pat. No. 5,850,517 also fails to teach or suggest the use of mobile agents in the context of event scheduling.

Accordingly, it is appreciated that in order to overcome the deficiencies and shortcomings of the existing client-server approach for event scheduling, it would be advantageous to have an automated method and system for event scheduling that uses one or more mobile agent(s) dispatched in the network for automatically negotiating the best timeframe for carrying out said event. The present invention provides such a method and system.

### SUMMARY OF THE INVENTION

In one aspect, the present invention is a method for scheduling a multi-party event using a scheduler mobile agent, the method starting by transmitting the scheduler mobile agent to a calendar server storing an electronic calendar of a participant to the event. Upon arrival at the calendar server, the scheduler mobile agent retrieves from the electronic calendar calendar information related to the participant, and uses the calendar information for scheduling the multi-party event.

In another aspect, the invention is a communications system comprising a scheduler mobile agent for scheduling a multi-party event with at least a participant, and a calendar server storing an electronic calendar of the participant, wherein the scheduler mobile agent is sent to the electronic calendar and upon arrival, retrieves calendar information related to the participant, and schedules the multi-party event using the calendar information.

In yet another aspect, the invention is a scheduler mobile agent for scheduling a multi-party event comprising a user interface for receiving identities of one or more intended participants to the multi-party event; an information retrieval module for retrieving calendar information related to the one or more participants from one or more calendar servers; and a date identifier for scheduling the multi-party event using the retrieved calendar information.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is a high-level network diagram illustrative of the preferred embodiment of the present invention;

FIG. 2 is an exemplary functional block diagram showing a preferred implementation of the invention related to a scheduler mobile agent; and

FIG. 3 is another high-level network diagram illustrative of a variant of the preferred embodiment of the present invention.

### DETAILED DESCRIPTION OF THE PREFERRED EMBODIMENTS

The innovative teachings of the present invention will be described with particular reference to numerous exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views, and the various elements depicted are not drawn to scale.

According to the present invention, in order to schedule a multiparty event, one or more mobile agent, are dispatched in the network with the meeting information desired by the event organizer, for automatically scheduling the conference on behalf of the participants, instead of having the participants manually consulting the calendars' information like in the prior art client/server architecture. According to the invention, the mobile agents visit the servers, access the agendas, retrieve the required information, and identify the each party's appropriate date and time for the meeting. Finding a suitable date for the several potential participants may also sometimes require the rescheduling of some events that have been previously arranged by some participants. Thus, the present invention proposes to use mobile agents that act as personal agents on behalf the participants for the scheduling and negotiation inherent to event scheduling and rescheduling.

A mobile agent is an autonomous and goal oriented software entity that acts on behalf of another entity and has the ability to transports itself across physical networks' nodes. It transfers its computational logic, i.e. code, data and running state, to remote hosts, taking advantage of local resources and services along with its proactive-ness and reactive-ness. The mobile agent execution requires a specific environment commonly called platform. Mobile agent platforms offer basic facilities including services for mobility, communication, naming, location, and security. Mobile agent platforms may be implemented using JAVA™ applications running on top of various operating systems, although different implementations may exist.

Mobility is the primary characteristic of mobile agents, not necessarily intelligence. Mobile agents implement in various degrees the concepts developed by the artificial intelligence community. Their mobility borrows a lot from process migration, which comprises transferring a process from one computer to another, wherein the process is an operating system abstraction including the code, the data, and the state of the running application.

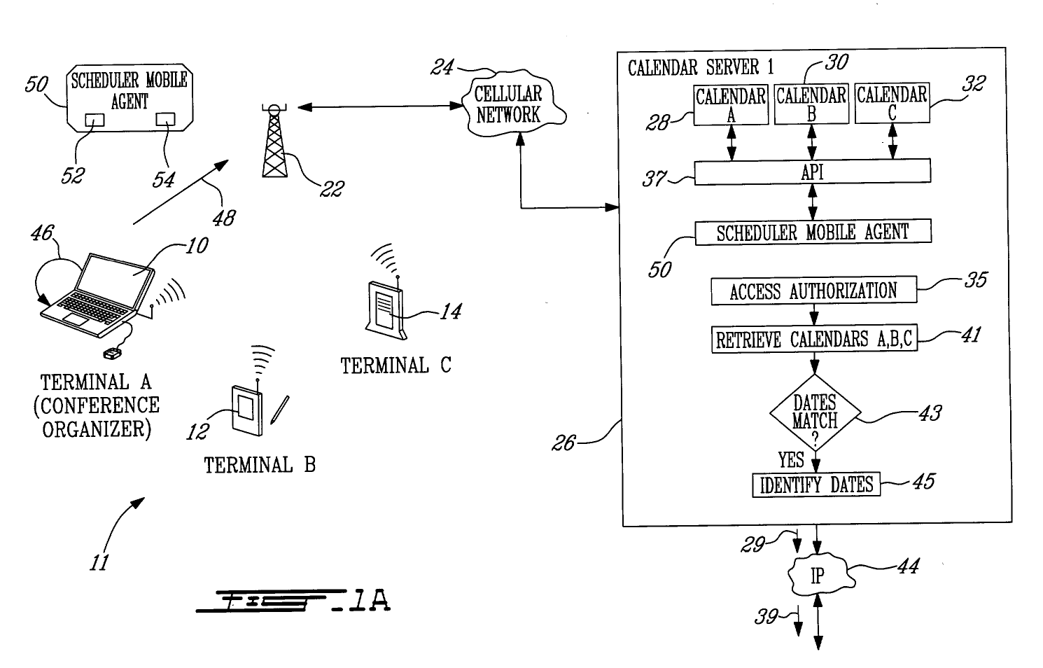

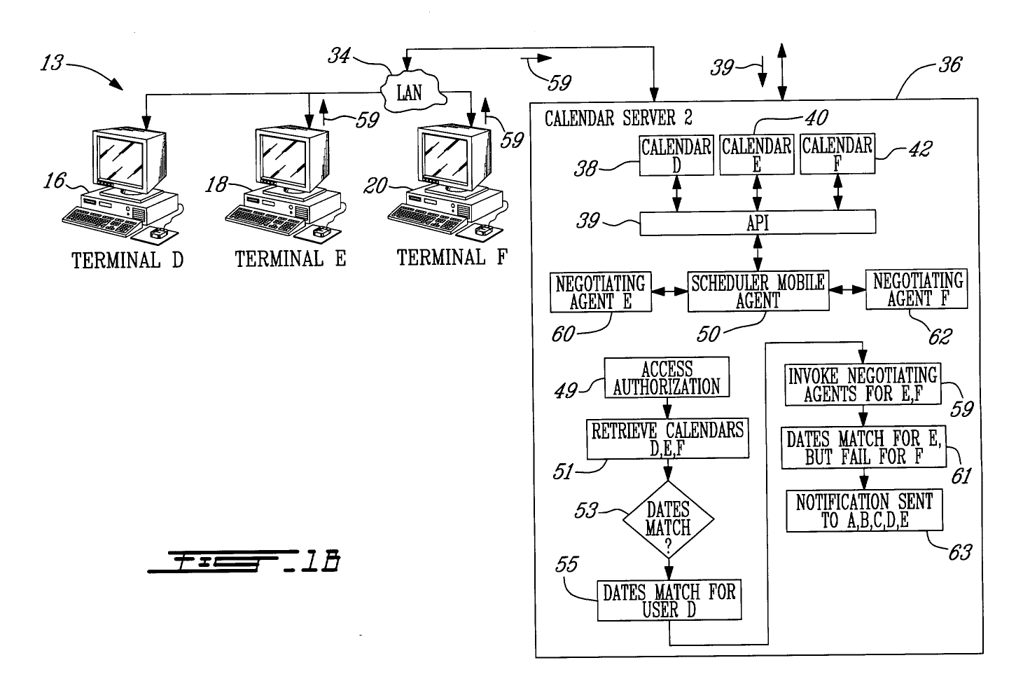

Reference is now made to FIG. 1, which illustrates an exemplary high-level network diagram of the preferred embodiment of the present invention. Shown in FIG. 1, are 6 user terminals of various types 10, 12, 14, 16, 18, and 20 used by 6 different users noted A-F. The terminals A, B, and C, noted 10, 12 and 14 may be wireless terminals and may communicate via one or more base station(s) 22 of one or more cellular network(s) 24 with a calendar server 26 that comprises calendars 28, 30, and 32 for each one of the users A, B, and C. Each calendar may store scheduled conferences, meetings, and appointments for its corresponding owner-user. Users D, E and F communicate via their respective personal computer (PC) terminals 16, 18, and 20 through a Local Area Network (LAN) 34 with their own calendar server 36, which stores their own respective calendars 38, 40, and 42. Calendars servers 26 and 36 may also be linked together via, for example, an IP-based network such as the Internet 44.

In the exemplary scenario described in relation to FIG. 1, it is assumed that user A desires to organize a videoconference, and that the targeted participants for the videoconference are A (the organizer), B, C, D, E, and F, although the videoconference would be carried on with (at least) 4 confirmed participants out of a maximum of 6. For the purpose of the present exemplary scenario, it is assumed that users A, B, and C reside in the domain 11 controlled by the calendar server 26, while users D, E, and F reside in the domain 13 controlled by the calendar server 36. The calendars of each user, also called herein electronic agendas, are stored on one or the other server, as shown. Each one of the servers 26 and 36 not only comprises the calendars, but also an Application Programmer Interface (API) 37 and 39 respectively that facilitates the exchange of information between the calendars and the mobile agents of the users.

In action 46, event organizer user A decides to schedule the videoconference. User A provides the identities 52 of the targeted participants along with a timeframe 54 for scheduling the videoconference. According to the invention, in action 48, a scheduler mobile agent 50 of organizer user A is sent to the calendar server 26 on behalf of the organizer A for scheduling the videoconference with the other intended participants, the scheduler mobile agent 50 comprising the identities 52 of the targeted participants and the attempted timeframe 54. Once it reaches the calendar server 26, in action 35, the scheduler mobile agent 50 may first obtain authorization from the users A, B, and C for accessing their calendars, although this step is optional depending upon the nature of the implementation of the calendar server. The scheduler mobile agent 50 successively retrieves the calendars of the participant users A, B, and C for the selected timeframe 54, action 41, and processes the calendar information in order to identify a date and time where all three targeted participants A, B, and C are available. In action 43, it is determined whether or not matching dates are found for users A, B, and C, and in action 45, for the sake of the present example, it is assumed that at least one possible date is identified. Once the scheduler mobile agent 50 identifies on the server 26 at least one possibility (preferably under the form of a sub-set of the timeframe 54) for scheduling the videoconference of users A, B, and C, in action 29, it moves to server 36 with the identified possibility, which stores the calendars 38, 40, and 42 of the remaining participants D, E, and F. When moving to server 36, the scheduler mobile agent brings with itself the determined subset timeframe(s) wherein users A, B, and C were determined to be able to carry on the videoconference event. On the calendar server 36, the mobile agent behaves as described hereinabove, and first obtains the authorization of users D, E, and F to access their calendars, action 49. Then, the scheduler mobile agent 50 retrieves the calendar information of users D, E, and F for the attempted subset timeframe, action 51. Based of the retrieved calendar information, the scheduler mobile agent 50 further attempts to figure out whether users D, E, and F are available on any of the dates where A, B, and C are available too, action 53. The mobile agent 50 detects, for example, three dates that are suitable for the videoconference for user D, but fails to find a date that that satisfies users E and F, action 55. Because the majority of users can attend the videoconference on the identified dates, in action 59 the mobile agent 50 proposes the attempted dates for the videoconference to the negotiating agents 60 and 62 of users E and F for which no initial availability was found, by invoking or calling these negotiating agents in server 36. The negotiating agents 60 and 62 are responsible for the rescheduling of previous appointments, which may be based on a prioritization of already existing appointments. They also store personal preferences and renegotiating rules for conflicting appointments for the user they represent. The negotiating agents may be stored on the user's own terminals or on network servers. In the present exemplary scenario, it is assumed that the negotiating agents 60 and 62 were stored on terminals 18 and 20 respectively, and when invoked, were displaced toward the calendar server 36, action 59. It is further assumed that the negotiating agent 60 of user E is able to reschedule one of the previous engagements of user E, and thus can free some space for carrying on the videoconference on one of the selected dates, while the negotiating agent 62 of user F could not reschedule any of his previous engagements, action 61. The negotiation performed between the negotiating agents 60 and 62, on one side, and the scheduler mobile agent 50 on the other side, may be done based on priorities that are assigned to existing appointments versus the priority of the videoconference meeting that is being attempted. For example, if a meeting of a given user that conflicts with the videoconference has a lower priority, it can be displaced or simply cancelled for freeing up the timeframe for the more important videoconference. With reference to the exemplary scenario of FIG. 1, it is therefore concluded in action 61 by the scheduler mobile agent 50 that the quorum of at least 4 participants to the videoconference is reached, as previously required for carrying on the videoconference, with the 5 users A, B, C, D, and E having accepted the proposed date and time, but without user F which negotiating agent 62 was unable to free up any of the required timeframe. Finally, the mobile agent 50 may sends a notification with the meeting details to the 5 confirmed participants A, B, C, D, and E, action 63.

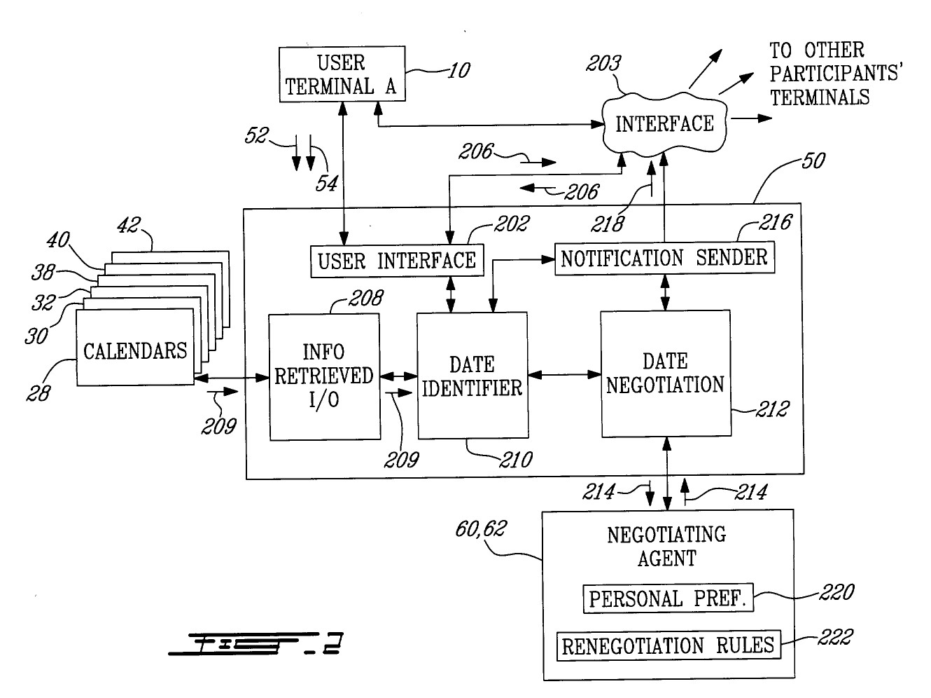

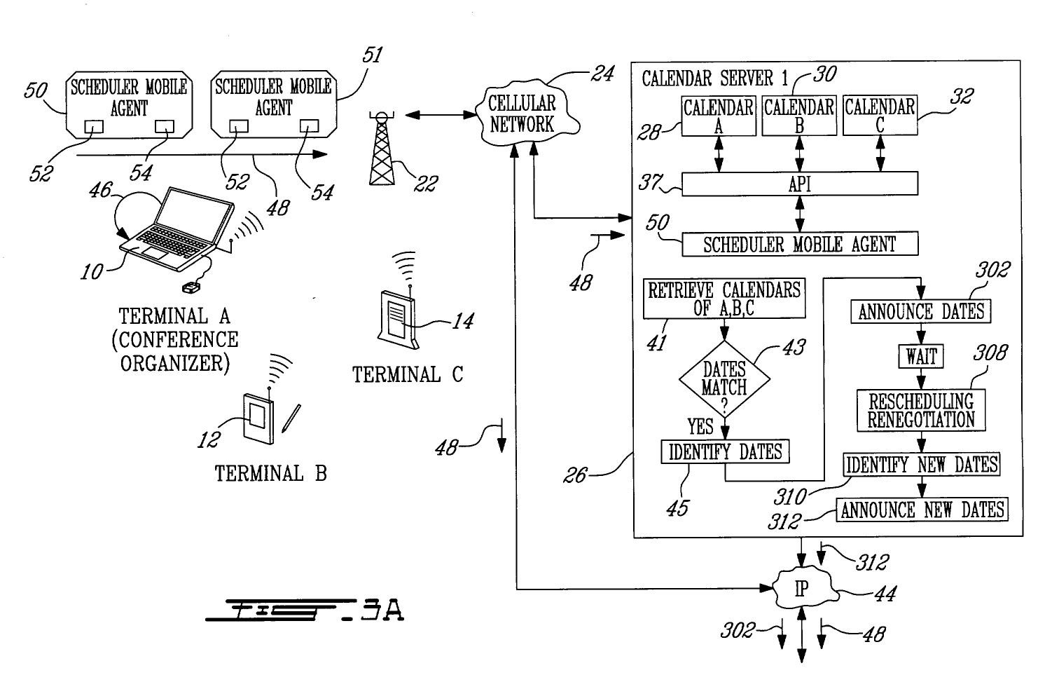

Referring now to FIG. 2, depicted therein is an exemplary functional block diagram illustrating a preferred implementation of the invention related to the scheduler mobile agent 50 that was also briefly described in relation to FIG. 1. First, the scheduler mobile agent 50 may comprise a user interface 202 that interacts with the event organizer user terminal A 10 to get the list of participants and their identities 52, and the selected timeframe 54 for the conference to be scheduled. The user interface 202 may further interact, action 206, via various types of interfaces 203 with each one of participants to the conference in order to get the authorization to access their electronic agendas. An information retrieval module 208 of the scheduler mobile agent 50 communicates with the calendars 28, 30, 32, 38, 40, and 42 in order to retrieve the calendar information 209 required to identify the dates where all targeted participants are available. The scheduler agent 50 further comprises a date identifier module 210 that uses the information 209 retrieved from the calendars to identify possible dates and time slots for scheduling the conference. A date negotiator module 212 interacts with one or more negotiating agents, such as for example the negotiating agent 60 of the participant E in order to negotiate rescheduling of previously booked events, action 214, when conflicts are detected between the newly attempted event and previously booked events. According to the preferred embodiment of the invention, each user has its own negotiating agent. For example, users E and F have the negotiating agents 60 and 62 respectively, as described in relation to FIGS. 1-2, and these negotiating agents are preferably collocated with their corresponding calendars onto the same calendar server. For example the negotiating agent of user E may be located on the calendar server 36 that stores the calendar 40 of that user E, as previously described in relation to FIG. 1. The negotiating agents comprise personal preferences 220 and rescheduling rules 222 of the user it represents. Finally, the scheduler mobile agent 50 comprises a notification sender module 216 that is responsible to send a notification 218 with the final accepted schedule to the confirmed participants, once the date identifier 210, possibly in cooperation with the date negotiator 212, has identified a conference schedule.

According to the preferred embodiment of the present invention, once the user A inputs the list of the intended participants to the videoconference into the scheduler mobile agent 50 via the user interface 202, the scheduler mobile agent 50 may migrate from the organizer A's terminal 10 to each required calendar server, and stay there during the whole negotiation process that involves information retrieved from that particular calendar server. Once to the dates identification and negotiation is completed and the notification for the confirmation of the videoconference schedule is sent to the conference participants, the scheduler mobile agent 50 may be discarded, since its sole task of booking the conference is completed.

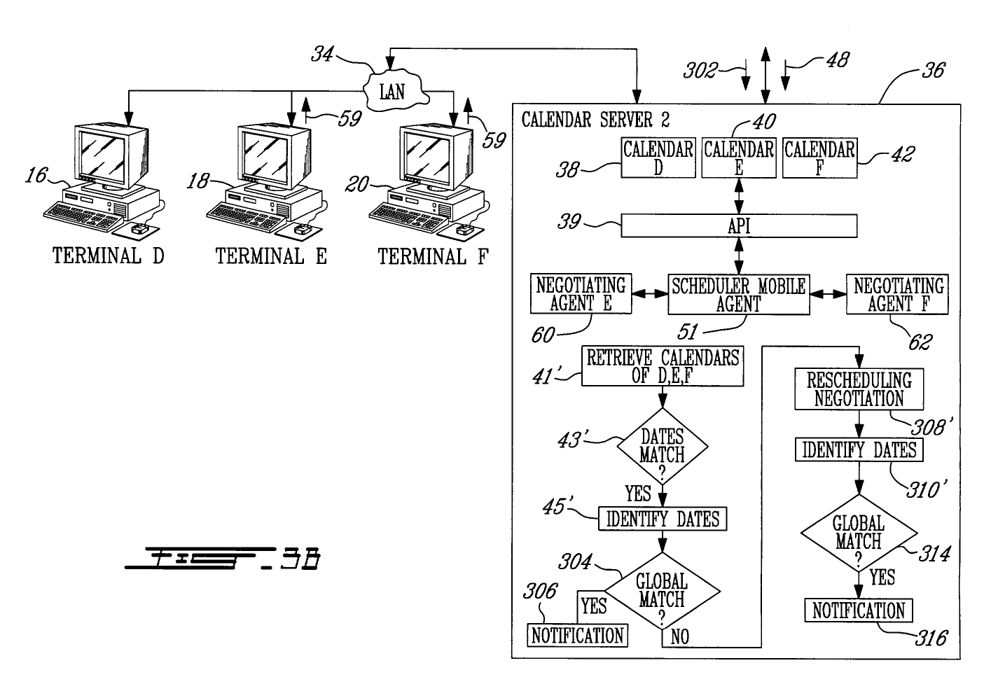

Reference is now made to FIG. 3, which illustrates an exemplary high-level network diagram of a variant of the preferred embodiment of the present invention. In FIG. 3, elements like or similar to those previously described in relation to FIG. 1 are described with the same numerals. FIG. 3 shows a variant of the preferred embodiment of the present invention, wherein instead of having one single scheduler mobile agent that successively visits each calendar server in order to determine the appropriate schedule for an event, a plurality of scheduler mobile agents are dispatched in the network with the same information as described for FIG. 1 for determining that schedule, thus creating a parallel processing for the event scheduling. With relation to FIG. 3, in action 46, user A decides to schedule a videoconference. For this purpose, user A provides the identities 52 of the targeted participants, along with a timeframe 54 for the scheduling of the videoconference. According to the present variant of the preferred embodiment of the invention, since two calendar servers 26 and 36 store the calendar information required to be evaluated for booking the videoconference, two scheduler mobile agents 50 and 51 are transmitted in action 48 from the organizer user terminal 10, the first scheduler mobile agent 50 being destined to the calendar servers 26, while the second scheduler mobile agent 51 is intended for the calendar server 36. The scheduler mobile agent 50 reaches the calendar server 26, and successively retrieves the calendars of users A, B, and C for the selected timeframe, action 41, and processes the information in order to identify a date and time where all three targeted participants are available. In action 43 it is determined whether or not matching dates are found for scheduling the videoconference for user A, B, and C, and in action 45, for the sake of the present example, it is assumed that a few possible dates are identified for videoconference for the users A, B, and C on the calendar server 26. Once the scheduler mobile agent 50 identifies on the server 26 at least one possibility for the videoconference of users A, B, and C, in action 302, it announces that one or more possibility, in the form of a scheduling proposal, to its peer scheduler mobile agent 51 on the calendar server 36, action 302.

Meanwhile, the scheduler mobile agent 51 reaches the calendar server 36 in action 48 and performs steps 41′, 43′, and 45′ that are similar to the previously described steps 41, 43 and 45, except for the fact that are performed on the calendars of users D, E, and F by the scheduler mobile agent 51. As a result of these steps, the scheduler mobile agent 51 also identifies in step 45′ its own proposal in the form of a series of dates and times for scheduling the videoconference for the users D, E, and F.

The scheduler mobile agent 51 on the calendar server 36 receives the proposal of the scheduler mobile agent 50, action 302, and in action 304 detects if there is at least one global match between its own proposal for the identified timeframe for the group of users D, E, and F and the one received from the scheduler mobile agent 50 with the identified timeframe for the group of users A, B, and C. If this is the case, the scheduler mobile agent 51 sends notifications for confirming the final proposal for the videoconference, action 306, to all the confirmed participants that conference. Otherwise, if there is no match between its own proposal and the one of the mobile agent 50, the scheduler mobile agent 51 proceeds to a renegotiation for rescheduling previously booked appointments for users D, E, and F, or for a subset of these users for which no availability is detected within the selected timeframe, by invoking the negotiation agents of the users D, E, and F, as previously described in relation to FIG. 1, action 308′. The scheduler mobile agent 51 may also request the scheduler agent 50 on the calendar server 26 to do the same, action 308, in order to expand its first proposal in relation to the timeframe for scheduling the videoconference. In actions 308 and 308′ the scheduler mobile agent 50 and the mobile scheduler agent 51 proceeds to this renegotiation and in actions 310 and 310′ they may both identify new dates proposals. In action 312, the scheduler mobile agent 50 announces the new dates proposal to the scheduler mobile agent 51, which detects in action 314 a global match between its own new proposal for the group of users D, E, and F and the one lately received from the scheduler mobile agent 50 for the group of users A, B, and C. Therefore, in action 316 the scheduler mobile agent 51 sends notifications to all participants A, B, c, D, E, and F for confirming the final schedule of that videoconference.

Based upon the foregoing, it should now be apparent to those of ordinary skill in the art that the present invention provides an advantageous solution, which offers easier and automatic negotiation of events on behalf of electronic calendar users, by providing the method, the system, and the mobile agent that allows for the dispatching in the network of a scheduler mobile agent that takes care of the automatically scheduling of events on behalf of the user. Although the system and method of the present invention have been described in particular reference to several exemplary preferred scenarios, it should be realized upon reference hereto that the innovative teachings contained herein are not necessarily limited thereto and may be implemented advantageously in various communication networks, using different protocols and methods for the detailed negotiation or renegotiation of the appointments. For example, various negotiation or renegotiation rules may be implemented depending upon the preferences of a particular implementation, such as for example confirming the booking of an event with a minimal number of confirmed participants out of a total number of participants, rescheduling low-importance events that were previously booked by a participant when these events conflict 10 with the newly scheduled event, setting a maximum number of renegotiation attempts or a maximum number of rescheduled conflicting events, setting a maximum number or an optimized number of scheduler mobile agents that may be simultaneously dispatched in the network for the scheduling of one single event, etc.

It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for scheduling a multi-party event using a scheduler mobile agent, the method comprising the steps of:
a) transmitting the scheduler mobile agent to a calendar server storing an electronic calendar of a participant to the event;
b) upon arrival at the calendar server, retrieving from the electronic calendar by the scheduler mobile agent calendar information related to the participant; and
c) using the calendar information for scheduling the multi-party event by the scheduler mobile agent.

2. The method claimed in claim 1, wherein the scheduler mobile agent comprises the identities of a plurality of participants to the multi-party event including the identity of the participant, and an intended timeframe for scheduling the multi-party event with the plurality of participants, and wherein the calendar information retrieved from the electronic calendar relates to the intended timeframe.

3. The method claimed in claim 2, wherein step c) comprises the steps of:
d) using the retrieved calendar information, identifying a timeframe of availability of the participant for carrying out the multi-party event; and
e) sending a confirmation notification to the participant for confirming the scheduling of the multi-party event on the identified timeframe of availability.

4. The method claimed in claim 2, wherein step c) comprises the steps of:
d) using the retrieved calendar information, detecting by the scheduler mobile agent that the participant has one or more previously booked events conflicting with the multi-party event; and
e) rescheduling the one or more events.

5. The method claimed in claim 2, wherein:
the plurality of intended participants includes a second participant;
the calendar server is a first calendar server storing the electronic calendar of the first participant and also another electronic calendar for the second participant;
and wherein step c) further comprises the steps of:
d) identifying by the scheduler mobile agent using the calendar information related to the first participant a first possible timeframe for carrying out the multi-party event for the first participant;
e) retrieving by the scheduler mobile agent from the electronic calendar of the second participant calendar information related to the second participant;
f) identifying by the scheduler mobile agent using the calendar information related to the second participant a second possible timeframe for carrying out the multi-party event for the second participant; and
g) determining by the scheduler mobile agent if the first possible timeframe and the second possible timeframe match for scheduling the multi-party event for the first and second participant.

6. The method claimed in claim 5, wherein the method further comprises the step of:
i) if the first and second possible timeframes match, scheduling the multi-party event for the first and second participant, and sending a confirmation notification to the first and second participants for confirming the scheduling of the multi-party event.

7. The method claimed in claim 5, wherein the method further comprises the step of:
i) if the first and second possible timeframes do not match, rescheduling previously booked events for at least one of the first and second participants for freeing up at least a portion of the intended timeframe for carrying out the multi-party event; and
scheduling the multi-party event for the first and second participant on the portion of the intended timeframe, and sending a confirmation notification to the first and second participants for confirming the scheduling of the multi-party event on the identified portion of the timeframe.

8. The method claimed in claim 2, wherein:
the plurality of participants includes a second participant;
the calendar server is a first calendar server storing the electronic calendar of the first participant;
and wherein step c) further comprises the steps of:
d) identifying by the scheduler mobile agent using the calendar information retrieved from the first calendar server a first possible timeframe for carrying out the multi-party event for the first participant;
e) moving the scheduler mobile agent on a second calendar server storing the electronic calendar of the second participant to the event;
f) upon arrival at the second calendar server, retrieving by the scheduler mobile agent from the electronic calendar of the second participant calendar information related to the second participant;
g) identifying by the scheduler mobile agent using the calendar information from the second calendar server a second possible timeframe for carrying out the multi-party event for the second participant; and
h) determining by the scheduler mobile agent if the first possible timeframe and the second possible timeframe match for scheduling the multi-party event for the first and second participant.

9. The method claimed in claim 8, wherein the method further comprises the step of:
i) if the first and second possible timeframes match, scheduling the multi-party event for the first and second participant, and sending a confirmation notification to the first and second participants for confirming the scheduling of the multi-party event.

10. The method claimed in claim 8, wherein the method further comprises the step of:
i) if the first and second possible timeframes do not match, rescheduling previously booked events for at least one of the first and second participants for freeing up at least a portion of the intended timeframe for carrying out the multi-party event; and
scheduling the multi-party event for the first and second participant on the portion of the intended timeframe, and sending a confirmation notification to the first and second participants for confirming the scheduling of the multi-party event on the identified portion of the timeframe.

11. The method claimed in claim 2, wherein the method further comprises prior to step b) the step of:
obtaining by the scheduler mobile agent an access authorization from the participant for retrieving the calendar information from the electronic calendar.

12. The method claimed in claim 2, wherein:
the scheduler mobile agent is a first scheduler mobile agent of at least a first and a second scheduler mobile agents used for scheduling the multi-party event; and
the plurality of participants to the multi-party event comprises i) the participant which is a first participant, having the electronic calendar which is a first electronic calendar stored on the calendar server which is a first calendar server, and ii) a second participant having an electronic calendar which is a second electronic calendar stored on a second calendar server;
wherein prior to step c) the method further comprises the steps of:
d) transmitting to the second calendar server the second scheduler mobile agent with the identities of the plurality of participants including the identity of the second participant, and an intended timeframe for scheduling the multi-party event; and
e) retrieving by the second scheduler mobile agent from the second electronic calendar calendar information related to the second participant; and
wherein step c) comprises the step of:
c.1) negotiating by the first and second scheduler mobile agents the scheduling of the multi-party event using the calendar information related to the first and second participants.

13. The method claimed in claim 12, wherein:
step c.1) further includes the step of identifying by the first scheduler mobile agent a first possible timeframe for the first participant to carry out the multi-party event using the calendar information related to the first participant;
step e) further includes the step of identifying by the second scheduler mobile agent a second possible timeframe for the second participant to carry out the multi-party event using the calendar information related to the second participant; and
step c.1) further includes the step of determining by at least one of the first and second scheduler mobile agents if the first possible timeframe and the second possible timeframe match for scheduling the multi-party event.

14. The method claimed in claim 13, wherein step c.1) further includes the step of:
f) if the first and second possible timeframes match, scheduling the multi-party event for the first and second participant, and sending a confirmation notification to the first and second participants for confirming the scheduling of the multi-party event.

15. The method claimed in claim 13, wherein step c.1) further includes the step of:
f) if the first and second possible timeframes do not match, rescheduling previously booked events for at least one of the first and second participants for freeing up at least a portion of the intended timeframe for carrying out the multi-party event; and
scheduling the multi-party event for the first and second participant on the portion of the intended timeframe, and sending a confirmation notification to the first and second participants for confirming the scheduling of the multi-party event on the identified portion of the timeframe.

16. A communications system comprising:
a scheduler mobile agent for scheduling a multi-party event with at least a participant;
a calendar server storing an electronic calendar of the participant;
wherein the scheduler mobile agent is sent to the electronic calendar and upon arrival, retrieves calendar information related to the participant, and schedules the multi-party event using the calendar information.

17. The system claimed in claim 16, wherein the scheduler mobile agent comprises the identities of a plurality of participants to the multi-party event including the identity of the participant, and an intended timeframe for scheduling the multi-party event with the plurality of participants, and wherein the calendar information relates to the intended timeframe.

18. The system claimed in claim 17, wherein the scheduler mobile agent uses the retrieved calendar information for identifying a timeframe of availability of the participant for carrying out the multi-party event, and sends a confirmation notification to the participant for confirming the scheduling of the multi-party event on the identified timeframe of availability.

19. The system claimed in claim 17, wherein the communication system further comprises:
a negotiating mobile agent for rescheduling previously booked events on behalf of the participant;
wherein the scheduler mobile agent uses the retrieved calendar information for detecting that the participant has one or more previously booked events conflicting with the multi-party event being scheduled, and invokes the negotiating mobile agent for rescheduling the one or more events.

20. The system claimed in claim 17, wherein:
the plurality of intended participants includes a second participant;
the calendar server is a first calendar server storing the electronic calendar of the first participant and also an electronic calendar for the second participant;
the scheduler mobile agent uses the calendar information related to the first participant to identify a first possible timeframe for carrying out the multi-party event for the first participant, retrieves from the electronic calendar of the second participant calendar information related to the second participant, further identifies a second possible timeframe for carrying out the multi-party event for the second participant using the calendar related to the second participant, and determines if the first possible timeframe and the second possible timeframe match for scheduling the multi-party event for the first and second participant.

21. The system claimed in claim 20, wherein if the first and second possible timeframes match, the scheduler mobile agent schedules the multi-party event for the first and second participant, and sends a confirmation notification to the first and second participants for confirming the scheduling of the multi-party event.

22. The system claimed in claim 20, wherein the communication system further comprises:
a first negotiating mobile agent for rescheduling previously booked events on behalf of the first participant; and
a second negotiating mobile agent for rescheduling previously booked events on behalf of the second participant;
wherein if the first and second possible timeframes do not match, at least one of the first and second negotiating agents reschedules previously booked events for a corresponding one of the first and second participants for freeing up at least a portion of the intended timeframe for carrying out the multi-party event, and the scheduler mobile agent schedules the multi-party event for the first and second participant on the portion of the intended timeframe, and sends a confirmation notification to the first and second participants for confirming the scheduling of the multi-party event on the portion of the timeframe.

23. The system claimed in claim 17 wherein:
the plurality of intended participants includes a second participant;
the calendar server is a first calendar server storing the electronic calendar of the first participant;
the scheduler mobile agent uses the calendar information retrieved from the first calendar server to identify a first possible timeframe for carrying out the multi-party event for the first participant, then moves to a second calendar server storing the electronic calendar of the second participant to the event, and upon arrival to the second calendar server retrieves from the electronic calendar of the second participant calendar information related to the second participant, identifies a second possible timeframe for carrying out the multi-party event for the second participant using the calendar information from the second calendar server, and determines if the first possible timeframe and the second possible timeframe match for scheduling the multi-party event for the first and second participant.

24. The system claimed in claim 23, wherein if the first and second possible timeframes match, the scheduler mobile agent schedules the multi-party event for the first and second participant, and sends a confirmation notification to the first and second participants for confirming the scheduling of the multi-party event.

25. The system claimed in claim 23, further comprising:
a first negotiating mobile agent for rescheduling previously booked events on behalf of the first participant; and
a second negotiating mobile agent for rescheduling previously booked events on behalf of the second participant;
wherein if the first and second possible timeframes do not match, at least one of the first and second negotiating agents reschedules previously booked events for at least one of the first and second participants for freeing up at least a portion of the intended timeframe for carrying out the multi-party event, and at least one of the first and second scheduler mobile agent schedules the multi-party event for the first and second participant on the portion of the intended timeframe and sends a confirmation notification to the first and second participants for confirming the scheduling of the multi-party event on the identified portion of the timeframe.

26. The system claimed in claim 17, wherein the scheduler mobile agent obtains an access authorization from the participant for retrieving the calendar information from the electronic calendar.

27. The system claimed in claim 17, wherein the scheduler mobile agent is a first scheduler mobile used for scheduling the multi-party event and the plurality of participants comprises i) the participant which is a first participant, having the electronic calendar which is a first electronic calendar stored on the calendar server which is a first calendar server, and ii) a second participant, and the system further comprises:
a second scheduler mobile agent of the second participant; and
a second calendar server storing a second electronic calendar of the second participant;
wherein the second scheduler mobile agent is sent to the second calendar server with the identities of the plurality of participants to the multi-party event including the identity of the second participant, and an intended timeframe for scheduling the multi-party event, and upon arrival to the second calendar server, the second scheduler mobile agent retrieves calendar information related to the second participant, and negotiates with the first scheduler mobile agent the scheduling of the multi-party event.

28. The system claimed in claim 27, wherein:
the first scheduler mobile agent uses the calendar information related to the first participant to identify a first possible timeframe for the first participant to carry out the multi-party event;
the second scheduler mobile agent uses the calendar information related to the second participant to identify a second possible timeframe for the second participant to carry out the multi-party event; and
at least one of the first and second scheduler mobile agents determines if the first possible timeframe and the second possible timeframe match for scheduling the multi-party event.

29. The system claimed in claim 28, wherein if the first and second possible timeframes match, at least one of the first and second mobile agents schedules the multi-party event for the first and second participant, and sends a confirmation notification to the first and second participants for confirming the scheduling of the multi-party event.

30. The system claimed in claim 28, further comprising:
a first negotiating mobile agent for rescheduling previously booked events on behalf of the first participant; and
a second negotiating mobile agent for rescheduling previously booked events on behalf of the second participant;
wherein if the first and second possible timeframes do not match, at least one of the first and second negotiating agents reschedules previously booked events for at least one of the first and second participants for freeing up at least a portion of the intended timeframe for carrying out the multi-party event, and at least one of the first and second scheduler mobile agent schedules the multi-party event for the first and second participant on the portion of the intended timeframe and sends a confirmation notification to the first and second participants for confirming the scheduling of the multi-party event on the identified portion of the timeframe.

31. A scheduler mobile agent for scheduling a multi-party event comprising:
a user interface for receiving identities of one or more intended participants to the multi-party event;
an information retrieval module for retrieving calendar information related to the one or more participants from one or more calendar servers; and
a date identifier for scheduling the multi-party event using the retrieved calendar information.

32. The scheduler mobile agent of claim 31 further comprising:
a notification sender module for sending a confirmation notification confirming the scheduling of the multi-party event to the one or more participants.

33. The scheduler mobile agent claimed in claim 31 further comprising:
a date negotiator module for renegotiating previously booked events conflicting with the multi-party event.
